(19) United States
(12) Patent Application Publication
(10) Pub. No.: US 2014/0259000 A1
(43) Pub. Date: Sep. 11, 2014

(54) Mitigating Issues Due to Firmware Upgrades in a Converged Network Environment

(71) Applicant: CISCO TECHNOLOGY, INC., San Jose, CA (US)

(72) Inventors: Claudio Desanti, Oakland, CA (US); Joe Pelissier, Hillsboro, OR (US)

(73) Assignee: Cisco Technology, Inc., San Jose, CA (US)

(21) Appl. No.: 13/785,520

(22) Filed: Mar. 5, 2013

(51) Int. Cl. G06F 9/445

(52) U.S. Cl. CPC G06F 8/65
USPC 717/171

(57) ABSTRACT

An upgrade process is provided to upgrade first and second switches in a converged network handling storage area network traffic and data network traffic, in which the first and second switches are coupled to a host, e.g., a Fibre Channel over Ethernet (FCoE) via distributed network links, e.g., Virtual PortChannel links or Distributed Resilient Interconnect (DRNI) links. The first switch is isolated from the host so that all distributed network links traffic associated with the host is transferred to the second switch. The firmware of the first switch is upgraded while all distributed network links traffic associated with the host is handled by the second switch. The firmware of the second switch is upgraded is a similar manner while all distributed network links traffic associated with the host is handled by the first switch.

### TECHNICAL FIELD

The present disclosure relates to converged network environments.

### BACKGROUND

Converged networks enable significant cost savings by allowing the use of a single converged network infrastructure for both storage area network (SAN) traffic and local area network (LAN) traffic. However, network convergence presents some technical issues due to the fact that a single switching platform is used for both storage and LAN traffic. One such technical issue is that storage administrators do not want a firmware upgrade of a switch that resolves some LAN bugs to introduce some SAN bugs.

### BRIEF DESCRIPTION OF THE DRAWINGS

FIG. 1 is a block diagram showing an example of a simplified converged network environment in which first and second switches that redundantly handle storage area network traffic and local area network traffic are upgraded according to an upgrade procedure presented herein.

FIG. 2 is flow chart of the upgrade procedure presented herein.

FIGS. 3A-3D and 4A-4D are diagrams showing the state of first and second switches during the upgrade procedure.

FIG. 5 is a block diagram of a management server that is configured to perform the upgrade procedure presented herein.

### DESCRIPTION OF EXAMPLE EMBODIMENTS

### Overview

An upgrade process is presented herein to upgrade first and second switches in a converged network handling storage area network traffic and data network traffic, in which the first and second switches are coupled to a host via distributed network links, such as Distributed Resilient Network Interconnect (DRNI) links or Virtual PortChannel links. The first switch is isolated from the host so that all distributed network links traffic associated with the FCoE host is transferred to the second switch. The firmware of the first switch is upgraded while all distributed network links traffic associated with the host is handled by the second switch. Connectivity of the first switch to the host is re-established so that all distributed network links traffic associated with the host is re-enabled on both the first and second switches. The second switch is then isolated from the host so that all distributed network links traffic associated with the host is transferred to the first switch. The firmware of the second switch is upgraded while all distributed network links traffic associated with the host is handled by the first switch. Connectivity of the second switch to the host is re-established so that all distributed network links traffic associated with the host is re-enabled on both the first and second switches. In one example, the storage area network traffic may be Fiber Channel over Ethernet (FCoE) traffic in which case the host is an FCoE host and the data network traffic may be Ethernet traffic.

### Example Embodiments

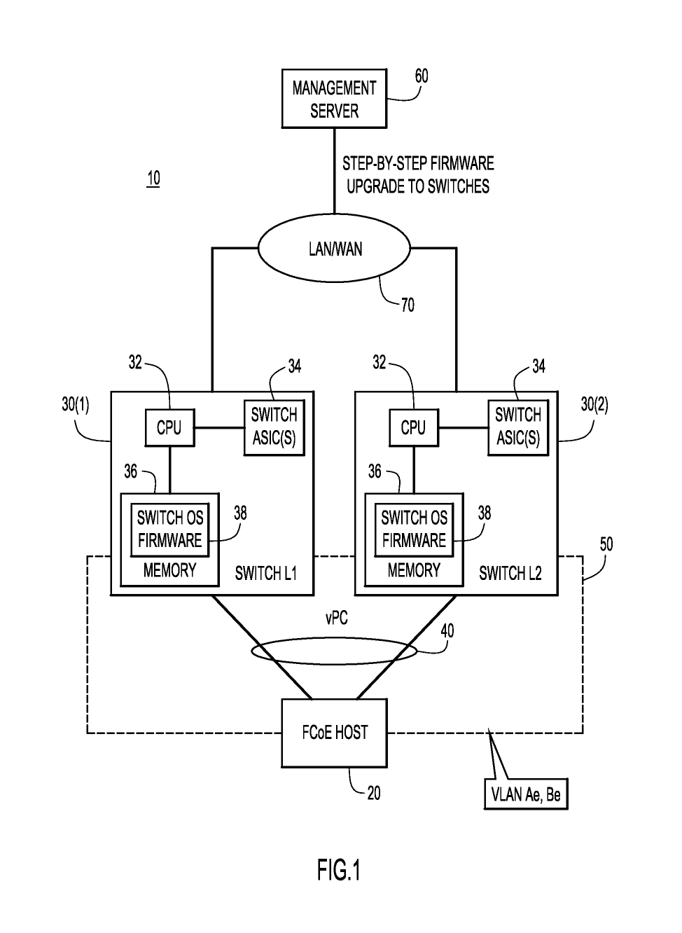

Referring first to FIG. 1, a block diagram is shown of a simplified converged network topology 10 comprising a Fibre Channel over Ethernet (FCoE) host 20 connected to two leaf switches 30(1) and 30(2). Leaf switches 30(1) and 30(2) are also referred to herein as switches L1 and L2, respectively.

The use of FCoE enables input/output (I/O) consolidation (i.e., network convergence): the consolidation of multiple separate networks into a single converged infrastructure. Specifically, FCoE enables the overlay of Fibre Channel (FC) based storage area networks (SANs) over a lossless Ethernet infrastructure, removing the need for native Fibre Channel Fabrics.

In a converged infrastructure, alignment of the typical redundancy model for SAN traffic to the proven techniques utilized for local area network (LAN) traffic is needed. Physical layer redundancy (i.e., resiliency to a single hardware fault) is related to the Ethernet physical infrastructure; therefore FCoE resiliency in a converged infrastructure is based on Ethernet best practices, e.g., Virtual PortChannels (vPCs). Fabric level redundancy is still provided through a double Fabric model (i.e., SAN A/SAN B), however the separation of the two SANs is logically implemented as two different virtual SANs (VSANs) that map to two different virtual LANs (VLANs) (i.e., VLAN A and B). FC traffic in SAN A becomes FCoE traffic in VLAN A, FC traffic in SAN B becomes FCoE traffic in VLAN B, and the LAN traffic is carried in one or more additional VLANs over the converged Ethernet infrastructure. In the example topology of FIG. 1, the FCoE host 20 is connected to switches 30(1) and 30(2) via redundant vPC links shown at 40. Moreover, switches 30(1) and 30(2) support traffic for both VLANs Aₑ and Bₑ as shown at reference numeral 50.

FIG. 1 further shows a non-exhaustive view of the components of each of the switches 30(1) and 30(2). Specifically, each switch includes a central processing unit (CPU) 32, one or more switch Application Specific Integrated Circuits (ASICs) 34, and memory 36 that stores firmware/software instructions for a switch operating system (OS) 38. The CPU 32 executes the instructions for the switch OS firmware 38 to control switch operations. The switch OS 38 needs to be updated from time-to-time to fix bugs, improve performance or introduce new features of the switch, for both SAN and LAN traffic.

An important technical issue related to network convergence is that a single switching platform is used for both SAN and LAN traffic. However, storage network administrators do not want a firmware upgrade on a switch that resolves some LAN bugs to introduce some new SAN bugs. The use of vPC for FCoE traffic mitigates this issue when the upgrade procedure presented herein is used.

According to the techniques presented herein, FCoE over vPC is relied upon to connect hosts to a network with two redundant switches. In this way, it is possible to leverage vPC to perform a step-by-step upgrade procedure that enables verification that the updated firmware is functional on one switch before moving forward to update the firmware on the other switch. While this description refers to Ethernet traffic, FCoE SAN traffic and vPCs, these are only examples, and the techniques presented herein are applicable to a network environment involving any type of data network traffic (in addition to Ethernet), any type of storage area network traffic (in addition to FCoE), and any type of distributed network links, such as Distributed Resilient Network Interconnect (DRNI) links of IEEE 802.1AXbq or vPC links. DRNI enables independence of the network management and control protocols, isolating each from the other's fault recovery events, and allows for forwarding of data frames belonging to any given service over the same physical path in both directions between two networks. vPCs allow links that are physically connected to two different switches to appear to a third downstream device as coming from a single device and as part of a single port channel. The third device can be a switch, a server, or any other networking device that supports IEEE 802.3ad PortChannels.

FIG. 1 shows that there is a management server (station) 60 connected to a LAN or wide area network (WAN) 70, via which the management serer 60 communicates with the switches 30(1) and 30(2). The management server 60 may be local to or remote from the switches 30(1) and 30(2). A network administrator can initiate the upgrade process from the management server 60.

There are several ways in which the upgrade process may be initiated. A network administrator may manually initiate the upgrade process via the management server 60 or scripts (written by an administrator) may initiate the upgrade process. Moreover, the upgrade process may be part of a management application running on the management server 60. Another possibility is for the administrator to initiate the upgrade process directly from each switch. Still another possibility is for a switch to expose a management interface to the administrator. The administrator logs into this interface on both switches, initiates the movement of traffic to the one switch, initiates the software upgrade on the other switch, and then restores the traffic to both switches. The switches would use a protocol such as File Transfer Protocol (FTP) to download the software/firmware update.

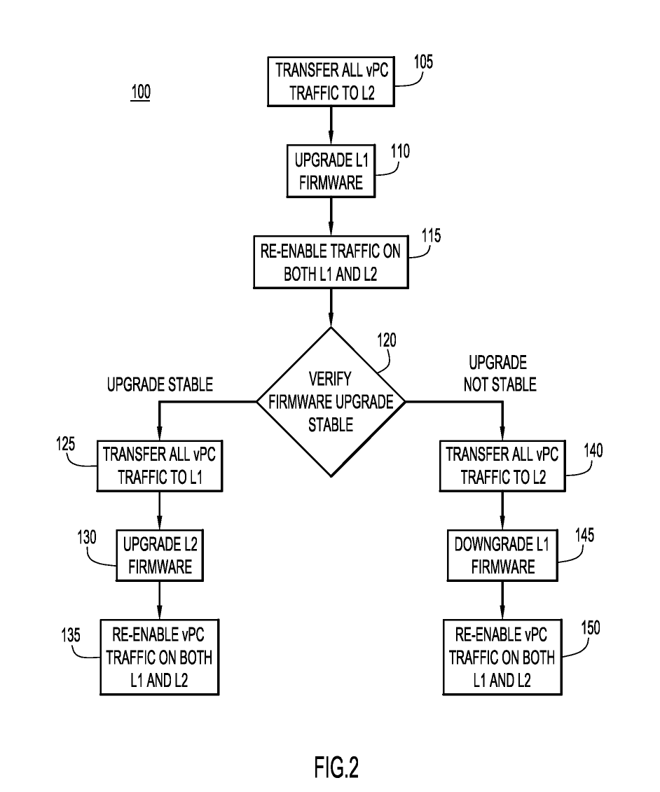

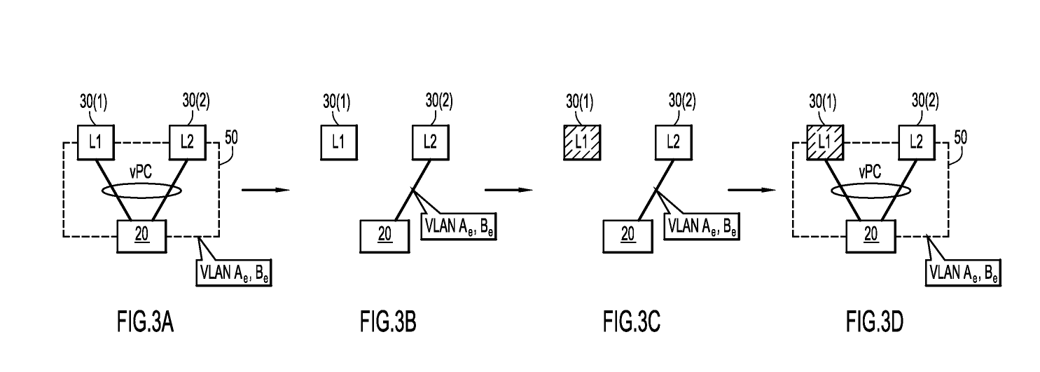

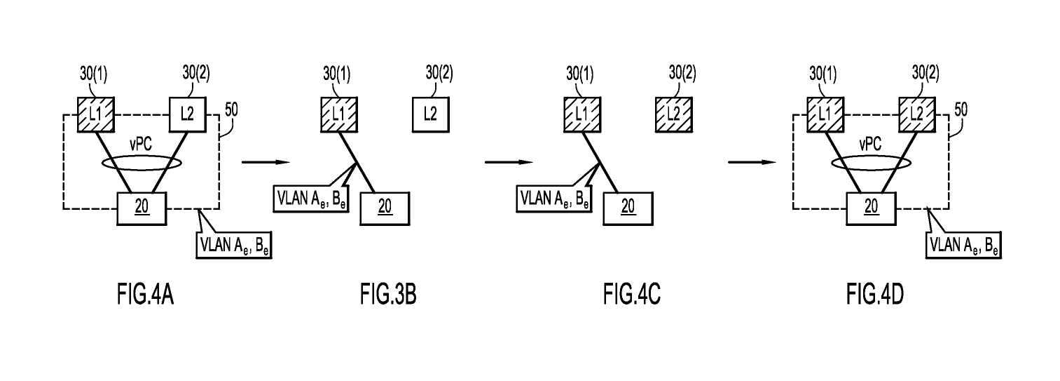

Reference is now made to FIG. 2, together with FIGS. 3A-3D and 4A-4D for a description of the upgrade process 100. The starting point, as shown in FIG. 3A, is one at which an FCoE host is connected to two non-upgraded leaf switches, L1 and L2. Switch L1 is to be upgraded first. The first step, at 105, is to move/transfer all the vPC state/traffic associated with the FCoE host 20 to switch L2, by isolating switch L1 from the FCoE host 20. This isolation operation is similar to how vPC would deal with a link failure case. The management server generates a command that is sent to switch L1 to isolate switch L1 from the FCoE host 20 so that all vPC traffic associated with the FCoE host 20 is transferred to switch L2. FIG. 3B shows the isolation of switch L1 from the FCoE host 20. From the FCoE host perspective there is no connectivity change, just a bandwidth change, because traffic for both VLANs Aₑ and Bₑ continues to run on the remaining link(s) of the vPC via switch L2. Thus, all vPC traffic associated with the FCoE switch is handled by switch L2.

With switch L1 isolated from the FCoE host 20, at step 110, the firmware upgrade to L1 is performed. The data for the upgrade is downloaded from the management server to the switch and installed in the switch L1. The upgraded switch L1 is shown by the cross-hatching of switch L1 in FIG. 3C. Next, at step 115, vPC traffic is re-enabled to the now upgraded switch L1. For example, the management server sends a command to switch L1 to re-establish connectivity of switch L1 to the FCoE host, so that all vPC traffic associated with the FCoE host is re-enabled on both switches L1 and L2. This is shown in FIG. 3D.

At step 120, it is verified whether the firmware upgrade of switch L1 works as expected and is otherwise stable. Examples of tests or monitoring that can be performed to verify that the firmware upgrade of switch L1 is stable and working as expected include verifying that the network continues to behave in a consistent manner for a period of time (e.g., 24 hours) and the specific features are performing as expected. If the upgraded firmware performs satisfactorily and it is determined to be stable, the same procedure can then be followed to upgrade switch L2 as well. As an alternative to the flow shown in FIG. 2, it is possible that verification of the upgraded switch L1 is made before re-establishing vPC traffic to it, and if the verification checks are successful, vPC traffic to switch L1 is thereafter re-established by re-establishing connectivity with the FCoE host. In either case, FIG. 4A shows the state of the switches L1 and L2 after switch L1 is successfully upgraded.

After it is determined that the upgrade of switch L1 is stable, the same procedure is repeated for switch L2. At step 125, switch L2 is isolated from the FCoE host 20 and all vPC traffic is transferred to switch L1. This is shown in FIG. 4B. For example, the management server sends a command to the switch L2 to isolate it from the FCoE host 20 so that all vPC traffic associated with the FCoE host is transferred to switch L1. At step 130, the firmware of switch L2 is upgraded (in a manner similar to step 110 described above). This is shown by the cross-hatching of switch L2 in FIG. 4C. After switch L2 is upgraded, connectivity of switch L2 to the FCoE host is re-established (by a command sent from the management server) so that all vPC traffic is re-enabled at step 135 so that both switches L1 and L2 are enabled to handle vPC traffic associated with the FCoE host. This is shown in FIG. 4D.

If at step 120, it is determined that the upgrade of switch L1 is not stable, then processing continues to step 140. At step 140, switch L1 is isolated from the FCoE host and all vPC traffic is transferred to switch L2. This may be achieved by the management server generating and sending a command to the first switch L1 to isolate it from the FCoE host so that all vPC traffic associated with the FCoE host 20 is transferred to the second switch L2. At step 145, switch L1 is downgraded back to its firmware state it was in prior to the upgrade. This may be achieved by a command sent by the management server to switch L1. In so doing, switch L1 is reverted back to its firmware OS state prior to the upgrade. At 150, a command is sent by the management server to the first switch L1 to re-establish connectivity to the FCoE host 20 so that vPC traffic associated with the FCoE host 20 is re-enabled on both switches L1 and L2. A network administrator can troubleshoot the cause of the instability after the upgrade, determine how to fix the upgrade, and repeat the process 100. It may not be practical to attempt to upgrade switch L2 if the upgrade of switch L1 was unsuccessful.

When the upgrade of switch L1 is determined to be successful, then it is likely that the upgrade of switch L2 will also be successful, and so it may not be necessary to perform the stability check for switch L2 after it is upgraded. However, it should be understood that the same stability checks for switch L1 may also be used for switch L2 after switch L2 is upgraded. If for some reason, problems are found, then switch L2 can be reverted back to its pre-upgraded state in a manner similar to that shown at steps 140, 145 and 150.

Management of the SAN and LAN firmware upgrade functions in an organization may be compartmentalized into an “infrastructure role”. In this way, only administrators entitled to upgrade firmware and to manage physical ports would be able to do so.

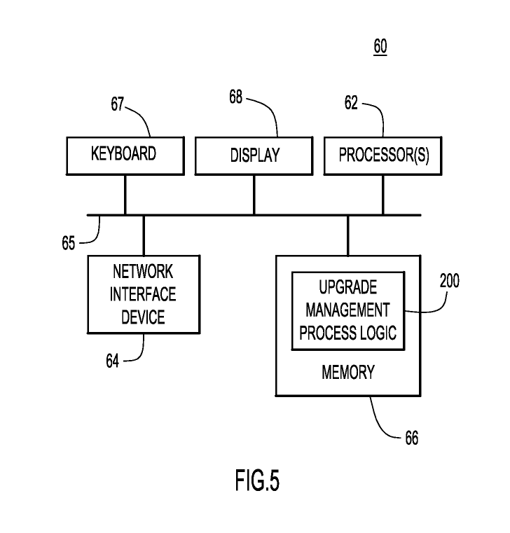

Turning now to FIG. 5, a block diagram is shown of a management server 60 that is configured to perform the firmware upgrade process depicted in FIGS. 2, 3A-3D and 4A-4D. The management server 60 includes one or more processors 62, a network interface unit 64, memory 66, a bus 65 and user interface devices such as a keyboard 67 and display 68. The network interface unit 64 enables communications over a LAN or WAN to communicate with switches under management of the management server 60. The memory 66 may comprise read only memory (ROM), random access memory (RAM), magnetic disk storage media devices, optical storage media devices, flash memory devices, electrical, optical, or other physical/tangible memory storage devices. The processor 62 is, for example, a microprocessor or microcontroller that executes instructions stored in memory 66, including instructions for upgrade management process logic 200. Thus, in general, the memory 66 may comprise one or more tangible (non-transitory) computer readable storage media (e.g., a memory device) encoded with software comprising computer executable instructions and when the software is executed (by the processor 62) it is operable to perform the operations described herein. When the processor 62 executes the upgrade management process logic 200, the management server 60 performs the operations described above in connection with FIGS. 2, 3A-3D and 4A-4D.

It should be understood that the functions of the management server 60 described herein may be part of a larger network management application. Moreover, the functions of the management server 60 may be hosted in a data center in a cloud computing environment, rather than being resident on a particular physical device.

In summary, presented herein are techniques for upgrading firmware of first and second switches connected to a host in a converged network that handles storage area network traffic and data network traffic. The first and second switches are coupled to a host via distributed network links. While the foregoing description and accompanying figures refer to vPC links, this is only an example, and these techniques are applicable to other types of distributed network links, such as Distributed Resilient Network Interconnect (DRNI) links of IEEE 802.1AXbq. The first switch is isolated from the host so that all distributed network links traffic associated with the host is transferred to the second switch. The firmware of the first switch is then upgraded while all distributed network links traffic associated with the host is handled by the second switch. Connectivity of the first switch to the host is then re-established so that all distributed network links traffic associated with the host re-enabled on both the first and second switches. The second switch is then isolated from the host so that all distributed network links traffic associated with the host is transferred to the first switch. The firmware of the second switch is upgraded while all distributed network links traffic associated with the host is handled by the first switch. Connectivity of the second switch to the host is re-established so that all distributed network links traffic associated with the host is re-enabled on both the first and second switches.

These techniques may be embodied or implemented by an apparatus (e.g., a management server) that has network connectivity with the first and second switches Likewise, these techniques may be embodied in one or more computer readable storage media encoded with software comprising executable instructions, and when the software is executed (by a processor), the processor is operable to perform these techniques.

The above description is intended by way of example only.

What is claimed is:

1. A method comprising:
in a converged network handling storage area network traffic and data network traffic in which first and second switches are coupled to a host via distributed network links, isolating the first switch from the host so that all distributed network links traffic associated with the host is transferred to the second switch;
upgrading firmware of the first switch while all distributed network links traffic associated with the host is handled by the second switch;
re-establishing connectivity of the first switch to the host so that all distributed network links traffic associated with the host is re-enabled on both the first and second switches;
isolating the second switch from the host so that all distributed network links traffic associated with the host is transferred to the first switch;
upgrading firmware of the second switch while all distributed network links traffic associated with the host is handled by the first switch; and
re-establishing connectivity of the second switch to the host so that all distributed network links traffic associated with the host is re-enabled on both the first and second switches.

2. The method of claim 1, further comprising:
verifying that operations of the first switch are stable after the firmware upgrade of the first switch.

3. The method of claim 2, wherein isolating the second switch from the host to transfer all distributed network links traffic associated with the host to the first switch is performed when operations of the first switch are determined to be stable after the firmware upgrade.

4. The method of claim 2, further comprising:
isolating the first switch from the host so that all distributed network links traffic associated with the host is transferred to the second switch when it is determined that operations of the first switch after the firmware upgrade are not stable;
downgrading the first switch back to its firmware state prior to the upgrade; and
re-establishing connectivity of the first switch to the host so that all distributed network links traffic associated with the host re-enabled on both the first and second switches.

5. The method of claim 1, wherein the isolating, upgrading and re-establishing operations are performed by a management server in communication with the first and second switches.

6. The method of claim 1, wherein the data network traffic comprises Ethernet traffic, the storage area network traffic comprises Fibre Channel over Ethernet (FCoE) traffic, the host is an FCoE host and the distributed network links are Virtual PortChannel links or Distributed Resilient Network Interconnect (DRNI) links.

7. A method comprising:
in a converged network handling storage area network traffic and data network traffic in which first and second switches are coupled to a host via distributed network links, isolating the first switch from the host so that all distributed network links traffic associated with the host is transferred to the second switch;
upgrading firmware of the first switch while all distributed network links traffic associated with the host is handled by the second switch;
re-establishing connectivity of the first switch to the host so that all distributed network links traffic associated with the host is re-enabled on both the first and second switches;
verifying that operations of the first switch are stable after the firmware upgrade;
if it is determined that operations of the first switch are stable after the firmware upgrade, isolating the second switch from the host so that all distributed network links traffic associated with the host is transferred to the first switch;
upgrading firmware of the second switch while all distributed network links traffic associated with the host is handled by the first switch; and
re-establishing connectivity of the second switch to the host so that all distributed network links traffic associated with the host is re-enabled on both the first and second switches.

8. The method of claim 7, further comprising:
isolating the first switch from the host so that all distributed network links traffic associated with the host is transferred to the second switch when it is determined that operations of the first switch after the firmware upgrade are not stable;
downgrading the first switch back to its firmware state prior to the upgrade; and
re-establishing connectivity of the first switch to the host so that all distributed network links traffic associated with the host is re-enabled on both the first and second switches.

9. The method of claim 7, wherein the isolating, upgrading, verifying and re-establishing operations are performed by a management server in communication with the first and second switches.

10. The method of claim 7, wherein the data network traffic comprises Ethernet traffic, the storage area network traffic comprises Fibre Channel over Ethernet (FCoE) traffic, the host is an FCoE host and the distributed network links are Virtual PortChannel links or Distributed Resilient Network Interconnect (DRNI) links.

11. One or more computer readable storage media encoded with software comprising computer executable instructions and when the software is executed operable to:
in a converged network handling storage area network traffic and data network traffic in which first and second switches are coupled to a host via distributed network links, generate and send a command to the first switch to isolate the first switch from the host such that all distributed network links traffic associated with the host is transferred to the second switch;
upgrade firmware of the first switch while all distributed network links traffic associated with the host is handled by the second switch;
generate and send a command to the first switch to re-establish connectivity of the first switch to the host so that all distributed network links traffic associated with the host is re-enabled on both the first and second switches;
generate and send a command to the second switch to isolate it from the host so that all distributed network links traffic associated with the host is transferred to the first switch;
upgrade firmware of the second switch while all distributed network links traffic associated with the host is handled by the first switch; and
generate and send a command to the second switch to re-establish connectivity of the second switch to the host so that distributed network links traffic associated with the host is re-enabled on both the first and second switches.

12. The computer readable storage media of claim 11, further comprising instructions operable to verify that operations of the first switch are stable after the firmware upgrade of the first switch.

13. The computer readable storage media of claim 11, further comprising instructions operable to:
generate and send a command to the first switch to isolate the first switch from the host so that all distributed network links traffic associated with the host is transferred to the second switch when it is determined that operations of the first switch after the firmware upgrade are not stable;
generate and send a command to the first switch to downgrade the first switch back to its firmware state prior to the upgrade; and
generate and send a command to the first switch to re-establish connectivity to the host so that distributed network links traffic associated with the host is re-enabled on both the first and second switches.

14. An apparatus comprising:
a network interface unit configured to enable communications with first and second switches coupled to a host via distributed network links in a converged network that handles storage area network traffic and data network traffic;
a memory;
a processor coupled to the network interface unit and the memory, wherein the processor is configured to:
generate a command to be sent to the first switch to isolate the first switch from the host so that all distributed network links traffic associated with the host is transferred to the second switch;
upgrade firmware of the first switch while all distributed network links traffic associated with the host is handled by the second switch;
generate and a command to be sent to the first switch to re-establish connectivity of the first switch to the host so that all distributed network links traffic associated with the host is re-enabled on both the first and second switches;
generate a command to be sent to the second switch to isolate the second switch from the host so that all distributed network links traffic associated with the host is transferred to the first switch;
upgrade firmware of the second switch while all distributed network links traffic associated with the host is handled by the first switch; and
generate a command to be sent to the second switch to re-establish connectivity of the second switch so that distributed network links traffic associated with the host is re-enabled on both the first and second switches.

15. The apparatus of claim 14, wherein the processor is further configured to verify that operations of the first switch are stable after the firmware upgrade of the first switch.

16. The apparatus of claim 15, wherein the processor is further configured to:
generate a command to be sent to the first switch to isolate the first switch from the host so that all distributed network links traffic associated with the host is transferred to the second switch when it is determined that operations of the first switch after the firmware upgrade are not stable;
downgrade the first switch back to its firmware state prior to the upgrade; and
generate a command to be sent to the first switch to re-establish connectivity to the host so that all distributed network links traffic associated with the host is re-enabled on both the first and second switches.

17. The apparatus of claim 14, wherein the data network traffic comprises Ethernet traffic, the storage area network traffic comprises Fibre Channel over Ethernet (FCoE) traffic, the host is an FCoE host and the distributed network links are Virtual PortChannel links or Distributed Resilient Network Interconnect (DRNI) links.

18. A system comprising:
first and second switches coupled to a host via distributed network links in a converged network handling storage area network traffic and Ethernet traffic; and
a management server in communication with the first and second switches, wherein the management server is configured to:
isolate the first switch from the host so that all distributed network links traffic associated with the host is transferred to the second switch;
upgrade firmware of the first switch while all distributed network links traffic associated with the host is handled by the second switch;
re-establish connectivity of the first switch to the host so that all distributed network links traffic associated with the host is re-enabled on both the first and second switches;
isolate the second switch from the host so that all distributed network links traffic associated with the host is transferred to the first switch;
upgrade firmware of the second switch while all distributed network links traffic associated with the host is handled by the first switch; and
re-establish connectivity of the second switch to the host so that all distributed network links traffic associated with the host is re-enabled on both the first and second switches.

19. The system of claim 18, wherein the management server is further configured to verify that operations of the first switch are stable after the firmware upgrade of the first switch.

20. The system of claim 19, wherein the management server is configured to isolate the second switch from the host to transfer all distributed network links traffic associated with the host to the first switch when operations of the first switch are determined to be stable after the firmware upgrade.

21. The system of claim 18, wherein the management server is further configured to:
isolate the first switch from the host so that all distributed network links traffic associated with the host is transferred to the second switch when it is determined that operations of the first switch after the firmware upgrade are not stable;
downgrade the first switch back to its firmware state prior to the upgrade; and
re-establish connectivity of the first switch to the host so that all distributed network links traffic associated with the host re-enabled on both the first and second switches.
